(19) United States
(12) Patent Application Publication
(10) Pub. No.: US 2025/0082986 A1
(43) Pub. Date: Mar. 13, 2025

(54) TREADMILL

(71) Applicant: Shenzhen Yile Dynamic Technology Co., LTD, Shenzhen (CN)

(72) Inventors: Ren LIU, Shenzhen (CN); Jinsong FAN, Shenzhen (CN)

(21) Appl. No.: 18/487,034

(22) Filed: Oct. 13, 2023

(30) Foreign Application Priority Data
Sep. 9, 2023 (CN) 202311168923.3

(51) Int. Cl. A63B 22/02; A63B 22/00

(52) U.S. Cl. CPC A63B 22/02; A63B 22/0023

(57) ABSTRACT

A treadmill, including a running platform, which includes a driving piece, a supporting piece and a border; the border is movably connected to the driving piece; the supporting piece is movably connected to the driving piece and is movably connected to the border; and the driving piece optionally drives the supporting piece to move to drive the border to move. In this way, a shorter translation stroke of the driving piece is converted into a longer rotating stroke of one end of the supporting piece through the supporting piece. Therefore, a stroke of the driving piece driving the running platform to move up and down can be enlarged, so that in a case that a longer stroke is required for adjustment, in-place adjustment can be achieved within a short time, and the requirement of rapid adjustment by a user can be met while energy consumption, noise and cost are reduced.

### CROSS REFERENCE

This application claims priority benefits to Chinese Patent Application No. 202311168923.3, filed Sep. 9, 2023, the contents of which are incorporated herein by reference.

### TECHNICAL FIELD

The present invention relates to the technical field of fitness equipment, and in particular to a treadmill.

### BACKGROUND

A running platform of a treadmill is designed with a slope to increase the exercise amount and exercise intensity of a user, and the exercise amount and exercise intensity of the user can be effectively adjusted by adjusting the slope of the running platform, so that the user can adjust the exercise amount and exercise intensity as required. However, a traditional treadmill driven by a motor often consumes a large amount of electricity, generates loud noise and has high cost. The speed of driving the movement is low in a case that other modes are used for driving. In a case that a longer stroke is required for adjustment, longer time is often required, which is difficult to meet the requirement of rapid adjustment by the user.

### SUMMARY

Based on this, it is necessary to provide a treadmill to solve at least one of the above problems.

The present application provides a treadmill, including a running platform. The running platform includes a driving piece, a supporting piece and a border; the border is movably connected to the driving piece; the supporting piece is movably connected to the driving piece; the supporting piece is movably connected to the border; and the driving piece optionally drives the supporting piece to move to drive the border to move.

Further, the running platform further includes a supporting foot, the supporting foot is connected to the supporting piece, and the supporting foot is rotatably connected to the border.

Further, the border is rotatably connected to the driving piece.

Further, the supporting piece is rotatably connected to the driving piece.

Further, one end of the supporting piece is rotatably connected to the border, and the other end of the supporting piece is movably connected to the supporting foot.

Further, the running platform further includes a first guide structure, the first guide structure is arranged on a first plate body, and the first guide structure guides the movement of one end, connected to the driving piece, of the supporting piece.

Further, one end of the supporting piece is rotatably connected to the supporting foot, and the other end of the supporting piece is movably connected to the border.

Further, the running platform includes a first guide structure, the first guide structure is arranged on the border, and the first guide structure guides the movement of one end, connected to the driving piece, of the supporting piece.

Further, the first guide structure is a sliding groove, and one end, connected to the driving piece, of the supporting piece is slidably arranged at the sliding groove.

Further, the supporting foot includes two first plate bodies, or/and the supporting foot includes two first plate bodies and a second plate body located between the two first plate bodies, and two ends of the second plate body are connected to the two first plate bodies, respectively.

According to the above treadmill, a shorter translation stroke of the driving piece is converted into a longer rotating stroke of one end of the supporting piece through the supporting piece. Therefore, a stroke of the driving piece driving the running platform to move up and down can be enlarged, so that in a case that a longer stroke is required for adjustment, in-place adjustment can be achieved within a short time, and the requirement of rapid adjustment by a user can be met while energy consumption, noise and cost are reduced.

### BRIEF DESCRIPTION OF THE DRAWINGS

The drawings are only used for illustrative description, and cannot be understood as a limitation to this patent; and the same reference numerals are used for components with the same structure and the same function. In the drawings:

FIG. 1 is a schematic diagram of an overall structure of a treadmill according to an embodiment of the present application;

FIG. 2 is a schematic diagram of an overall structure of a treadmill according to another embodiment of the present application;

FIG. 3 is a schematic front view of a structure of a treadmill according to an embodiment of the present application; and

FIG. 4 is a schematic sectional view of a direction A-A in FIG. 3.

### DESCRIPTION OF REFERENCE NUMERALS

treadmill—100; running platform—1; driving piece—11; first connecting end—1101; second connecting end—1102; supporting piece—12; border—13; first border—1301; second border—1302; supporting foot—14; first plate body—1401; second plate body—1402; first guide structure—15; second guide structure—16; first connecting piece—17; second connecting piece—18; control piece—19; roller—110.

### DETAILED DESCRIPTION OF THE EMBODIMENTS

The technical solutions in the embodiments of the present application are described below with reference to the accompanying drawings in the embodiments of the present application. In the description of the embodiments of the present application, “/” represents “or” unless otherwise specified. For example, A/B may indicate A or B; and “and/or” is merely an association relationship that describes associated objects, and indicates that there may be three relationships. For example, A and/or B may represent three cases: only A exists, both A and B exist, and only B exists. In addition, in the description of the embodiments of the present application, “a plurality of” means two or more.

Hereinafter, the terms “first”, “second” and the like are used only for description and shall not be interpreted as an indication or implication of relative importance or an implicit indication of the number of technical features. Thus, the feature defined by “first” and “second” can explicitly or implicitly include one or more characteristics.

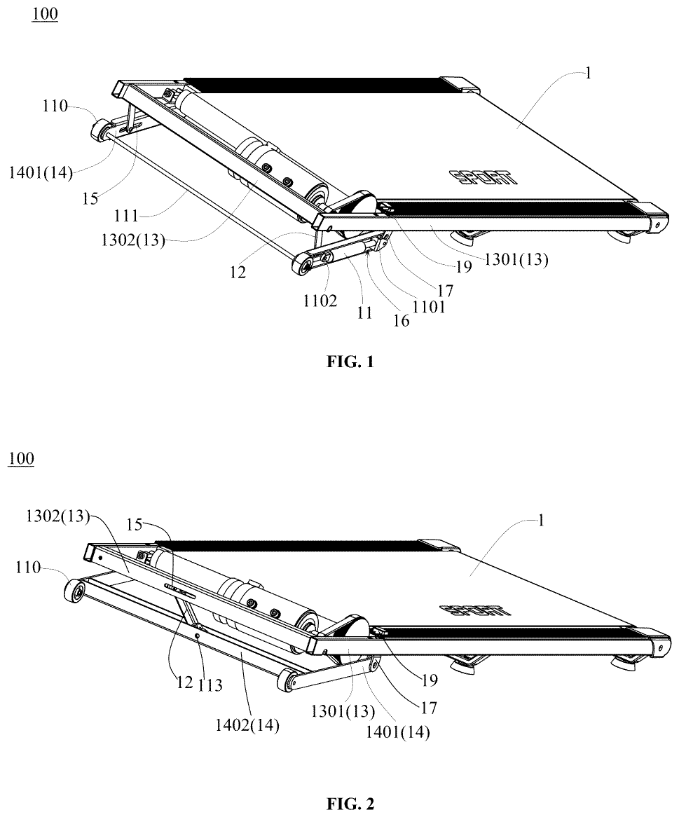

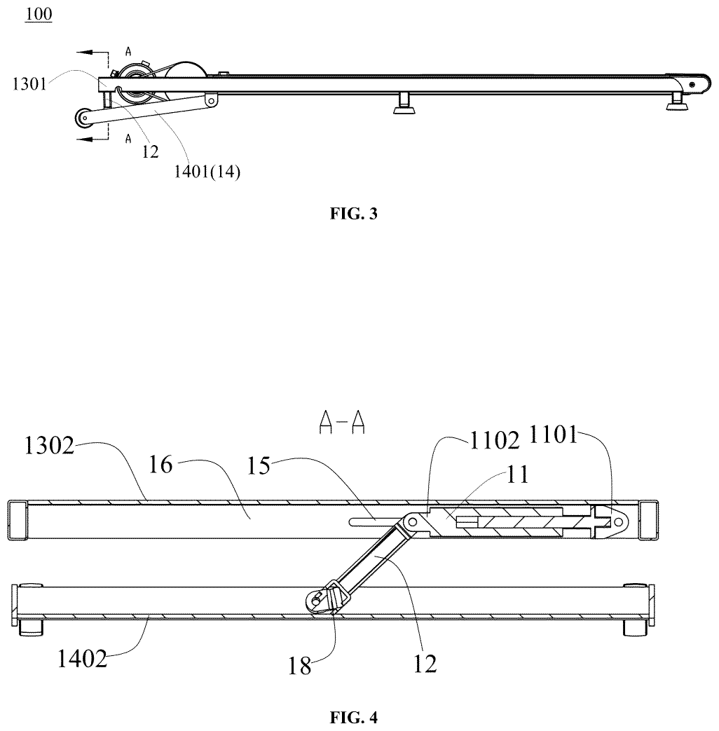

Referring to FIG. 1 to FIG. 4, in this embodiment, exemplarily, the embodiments of the present application provide a treadmill 100, including a running platform 1. The running platform 1 includes a driving piece 11, a supporting piece 12 and a border 13; the border 13 is movably connected to the driving piece 11; the supporting piece 12 is movably connected to the driving piece 11; the supporting piece 12 is movably connected to the border 13; and the driving piece 11 optionally drives the supporting piece 12 to move to drive the border 13 to move.

Specifically, the driving piece 11 includes a first connecting end 1101 and a second connecting end 1102, the first connecting end 1101 is a hinge, and the second connecting end 1102 is a lug.

Specifically, the supporting piece 12 is a connecting rod.

Specifically, the border 13 includes two first borders 1301 and a second border 1302 located between the two first borders 1301, and two ends of the second border 1302 are connected to the two first borders 1301, respectively.

Specifically, the first borders 1301 and the second border 1302 are square steel.

Optionally, the running platform 1 further includes a supporting foot 14, the supporting foot 14 is rotatably connected to the border 13, and the supporting foot 14 is connected to the supporting piece 12.

Optionally, the supporting foot 14 includes two first plate bodies 1401.

Optionally, the supporting foot 14 includes two first plate bodies 1401 and a second plate body 1402 located between the two first plate bodies 1401, and two ends of the second plate body 1402 are connected to the two first plate bodies 1401, respectively.

Specifically, the positions of the two first plate bodies 1401 correspond to the positions of the two first borders 1301, and the second border 1302 and the second plate body 1402 are arranged oppositely.

Optionally, the first border 1301 has a first connecting piece 17; the first connecting piece 17 is specifically a hinge; one side, corresponding to the first connecting piece 17, of the first plate body 1401 has a shaft hole; and the first plate body 1401 is hinged to the first border 1301 through the first connecting piece 17.

Optionally, the border 13 is rotatably connected to the driving piece 11.

Referring to FIG. 1, optionally, the driving piece 11 is arranged at the supporting foot 14, the first connecting end 1101 of the driving piece 11 is a hinge, and the driving piece 11 is hinged to the first connecting piece 17 of the first border 1301 through the first connecting end 1101.

Referring to FIG. 4, optionally, the driving piece 11 is arranged at the first border 1301, the first connecting end 1101 of the driving piece 11 is a hinge, the first border 1301 is provided with a shaft hole at a position corresponding to the first connecting end 1101, and the driving piece 11 is hinged to the shaft hole of the first border 1301 through the first connecting end 1101.

Optionally, the supporting piece 12 is rotatably connected to the driving piece 11.

Specifically, the second connecting end 1102 is a lug, the lug is provided with a shaft hole at a position corresponding to the supporting piece 12, the supporting piece 12 is also provided with a shaft hole at a position corresponding to the shaft hole of the lug, a shaft penetrates into the shaft hole of the lug and the shaft hole of the supporting piece 12, and the supporting piece 12 is rotatably connected to the driving piece 11 through the shaft.

Referring to FIG. 1, optionally, one end of the supporting piece 12 is rotatably connected to the border 13, and the other end of the supporting piece 12 is movably connected to the supporting foot 14.

Referring to FIG. 1, optionally, the number of the supporting pieces 12 is two; one end, facing the supporting foot 14, of each of the two supporting pieces 12 is slidably connected to the two first plate bodies 1401, respectively; and one end, away from the supporting foot 14, of each of the two supporting pieces 12 is rotatably connected to the two first borders 1301, respectively.

Referring to FIG. 1, optionally, the running platform 1 further includes a first guide structure 15; the first guide structure 15 is arranged at the first plate body 1401; and the first guide structure 15 guides the movement of one end, connected to the driving piece 11, of the supporting piece 12.

Referring to FIG. 2 to FIG. 4, optionally, one end of the supporting piece 12 is rotatably connected to the supporting foot 14, and the other end of the supporting piece 12 is movably connected to the border 13.

Referring to FIG. 2 to FIG. 4, optionally, the number of the supporting pieces 12 is one; one end, facing the supporting foot 14, of the supporting piece 12 is rotatably connected to the second plate body 1402; and one end, away from the supporting foot 14, of the supporting piece 12 is slidably connected to the second border 1302.

Referring to FIG. 2 to FIG. 4, optionally, the running platform 1 includes a first guide structure 15; the first guide structure 15 is arranged at the second border 1302; and the first guide structure 15 guides the movement of one end, connected to the driving piece 11, of the supporting piece 12.

Optionally, one end, facing the second plate body 1402, of the supporting piece 12 is a hinge; the second plate body 1402 is provided with a second connecting piece 18 at a position corresponding to the supporting piece 12; the second connecting piece 18 is a hinge; and one end, facing the second plate body 1402, of the supporting piece 12 is hinged to the second plate body 1402.

Optionally, the first guide structure 15 is a sliding groove; and one end, connected to the driving piece 11, of the supporting piece 12 is slidably arranged at the sliding groove.

Optionally, the running platform 1 further includes a second guide structure 16; the driving piece 11 further includes a first connecting end 1101 and a second connecting end 1102; the first connecting end 1101 is rotatably connected to the border 13; the second connecting end 1102 is rotatably connected to the supporting piece 12; the second connecting end 1102 is movable relative to the first connecting end 1101 to drive the supporting piece 12 to move; and the second guide structure 16 guides the movement of the second connecting end 1102 relative to the first connecting end 1101.

Specifically, the second guide structure 16 is specifically a U-shaped groove.

Optionally, the running platform 1 further includes a roller 110, and the roller 110 is arranged at the supporting foot 14.

One implementable working process of the treadmill 100 is as follows: referring to FIG. 1, the control piece 19 is controlled to enable the driving piece 11 to work; the driving piece 11 drives one end, corresponding to the supporting foot 14, of the supporting piece 12 to translate along the first guide structure 15; and at this time, one end, corresponding to the border 13, of the supporting piece 12 rotates around one end, corresponding to the supporting foot 14, of the supporting piece 12, and one end, corresponding to the border 13, of the supporting piece 12 pushes the border 13 to move towards or away from the supporting foot 14.

One implementable working process of the treadmill 100 is as follows: referring to FIG. 2 to FIG. 4, the control piece 19 is controlled to enable the driving piece 11 to work; the driving piece 11 drives one end, corresponding to the border 13, of the supporting piece 12 to translate along the first guide structure 15; and at this time, one end, corresponding to the supporting foot 14, of the supporting piece 12 rotates around one end, corresponding to the border 13, of the supporting piece 12, and one end, corresponding to the supporting foot 14, of the supporting piece 12 pushes the supporting foot 14 to move towards or away from the border 13.

According to the above treadmill 100, a shorter translation stroke of the driving piece is converted into a longer rotating stroke of one end of the supporting piece through the supporting piece. Therefore, a stroke of the driving piece driving the running platform to move up and down can be enlarged, so that in a case that a longer stroke is required for adjustment, in-place adjustment can be achieved within a short time, and the requirement of rapid adjustment by a user can be met while energy consumption, noise and cost are reduced.

In the description of the embodiments, unless otherwise specified, “a plurality of” means two or more. The foregoing descriptions are merely specific embodiments of the present application, but are not intended to limit the protection scope of this application. Any variation or replacement within the technical scope disclosed in this application shall fall within the protection scope of the present application. Therefore, the protection scope of the present application should be subject to the protection scope of the claims.

What is claimed is:

1. A treadmill, comprising a running platform, the running platform comprises a driving piece, a supporting piece and a border; the border is movably connected to the driving piece; the supporting piece is movably connected to the driving piece; the supporting piece is movably connected to the border; and the driving piece optionally drives the supporting piece to move to drive the border to move.

2. The treadmill according to claim 1, wherein
the running platform further comprises a supporting foot, the supporting foot is connected to the supporting piece, and the supporting foot is rotatably connected to the border.

3. The treadmill according to claim 1, wherein
the border is rotatably connected to the driving piece.

4. The treadmill according to claim 1, wherein
the supporting piece is rotatably connected to the driving piece.

5. The treadmill according to claim 2, wherein
one end of the supporting piece is rotatably connected to the border, and the other end of the supporting piece is movably connected to the supporting foot.

6. The treadmill according to claim 5, wherein
the running platform further comprises a first guide structure, the first guide structure is arranged on a first plate body, and the first guide structure guides the movement of one end, connected to the driving piece, of the supporting piece.

7. The treadmill according to claim 2, wherein
one end of the supporting piece is rotatably connected to the supporting foot, and the other end of the supporting piece is movably connected to the border.

8. The treadmill according to claim 7, wherein
the running platform comprises a first guide structure, the first guide structure is arranged on the border, and the first guide structure guides the movement of one end, connected to the driving piece, of the supporting piece.

9. The treadmill according to claim 6, wherein
the first guide structure is a sliding groove, and one end, connected to the driving piece, of the supporting piece is slidably arranged at the sliding groove.

10. The treadmill according to claim 2, wherein
the supporting foot comprises two first plate bodies, or/and the supporting foot comprises two first plate bodies and a second plate body located between the two first plate bodies, and two ends of the second plate body are connected to the two first plate bodies, respectively.
